(19) United States
(12) Patent Application Publication
(10) Pub. No.: US 2003/0159327 A1
(43) Pub. Date: Aug. 28, 2003

(54) Fishing lure loop line attachment

(76) Inventor: Benjamin C. Roemer, Manitowish Waters, WI (US)

Correspondence Address: RYAN KROMHOLZ & MANION, S.C., Post Office Box 26618, Milwaukee, WI, 53226, US

(21) Appl. No.: 10/080,842

(22) Filed: Feb. 22, 2002

(51) Int. Cl. A01K 85/00

(52) U.S. Cl. 43/42.13

(57) ABSTRACT

This invention is for a fishing lure wire frame having a non-twisted eye loop design that more effectively prevents the fishing line knotted to the lure from slipping out from the eye. The lure frame also has bends to provide greater support for the use of a shield head (or fish head) and to prevent spinner assemblies along either leg of the wire frame from slipping out-of-place. Overall, this wire frame design provides the fishing lure with more capability to be made into different shapes to attract fish to attack and improved effectiveness in casting and retrieving.

### FIELD OF THE INVENTION

This invention relates to an apparatus for providing an improved fishing lure.

### BACKGROUND OF THE INVENTION

This invention relates to a type of fishing lure spinner-bait, wherein mounted to either of two legs of a V-shaped wire frame are one or more rotatable, metal blades or spoons and a plug weight (typically made of lead) and hook. A skirt of tendrils is often slipped over the plug weight, followed behind by a grub slipped over the weight or along the hook. The fishing spinner lure is attached to the fishing line by tying a knot at the eye of the wire frame of the lure located at the vertex of the V. When the spinner lure is cast and retrieved, the spoons, tendrils and grub move and vibrate in a fashion that stimulates fish to bite. Spinner lures are commonly used in fishing for bass.

The prior art known to the inventor regarding spinner-bait lures in the same category as the present invention is illustrated in FIGS. 1 and 2. FIG. 1 illustrates a spinner-bait fishing lure frame with a V-shaped wire frame member with a twisted eye 10 at the vertex of the V for tying a fishing line. FIG. 2 illustrates a lure where V-shaped wire member is bent into an R-shape eye 15. One problem experienced in the prior art shown in FIG. 2 has been the tied knot of the fishing line 5 slipping out from the R-shaped eye 15 to along a leg of the wire member. This slippage can occur when casting the lure or when the lure becomes snagged. The slipped knot along either leg of the lure will interfere with the intended function of the lure in the water.

A problem experienced with the prior art shown in FIG. 1 has been the inability to use certain high-strength, high-memory materials like titanium because of necessary twisting and torsion exerted on the wire member in forming the eye 10. Memory refers to the ability of the wire frame to return to its original shape after undergoing various pulling and bending forces. If the wire frame of the spinner-bait lure is incapable of retaining its shape, the lure loses its effectiveness in attracting fish to attack.

Thus, there is a need for an improved spinner-bait lure with a non-twisted wire member that has an eye design that prevents line slippage.

One aspect of this invention provides a spinner-bait fishing lure frame comprising a generally V-shaped wire member having an eye loop at the vertex of the V, an upper leg and a lower leg. The eye loop formed in the wire member prevents the fishing line knotted to the lure from slipping out from the eye. In this invention, the eye is formed by a non-twisted loop in the wire member. Twisting of the wire member would otherwise prevent the use of materials such as titanium that exhibit superior strength and memory for fishing lure applications.

Another aspect of the invention is the inclusion of two bends located between the eye and the extended end of each leg member. The two bends provide greater support for the use of a shield head (or fish head) along the length of each wire leg member than compared to a wire member without bends. In addition, the bends prevent spinner assemblies along either leg of the wire frame from slipping out-of-place or towards the eye. This wire frame's ability to incorporate bends and yet retain the memory of its original shape makes the spinner-bait lure more effective in attracting fish to attack.

### DESCRIPTION OF DRAWINGS

FIG. 1 is a schematic view of a prior art fishing lure wire member frame, where the wire member is twisted to form an eye for attaching the fishing line to the lure.

FIG. 2 is a schematic representation of a prior art fishing lure wire member frame, where the wire member is bent into an R-shape to provide an eye for attaching the fishing line to the lure.

FIG. 3 is a schematic representation of a general spinner-bait lure, where the eye is formed by a non-twisted loop in the wire member of this invention.

FIG. 4 is an isolated schematic representation of the wire member of this invention.

FIG. 5 and FIG. 6 are schematic representations of the cross section of the upper and lower leg, respectively, of the wire frame member with a reference line along the wire member.

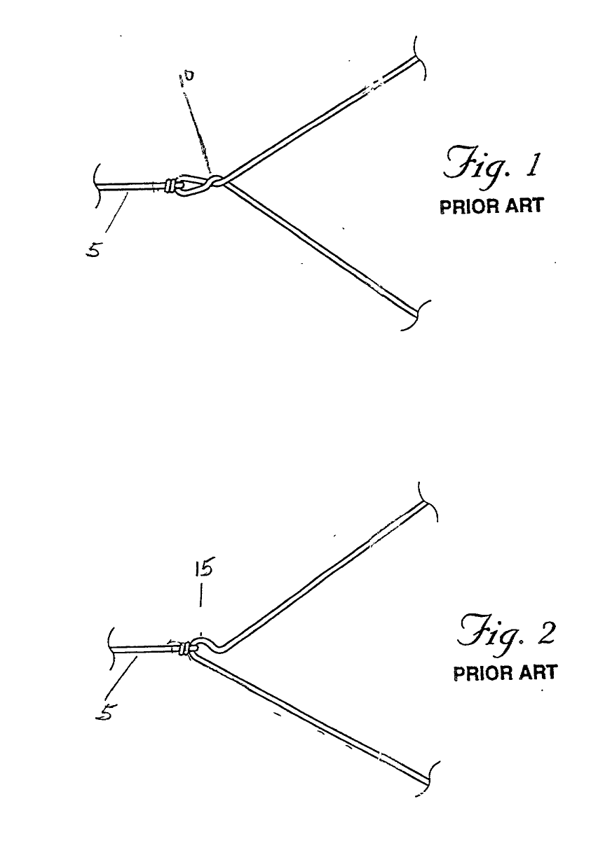

### DETAILED DESCRIPTION

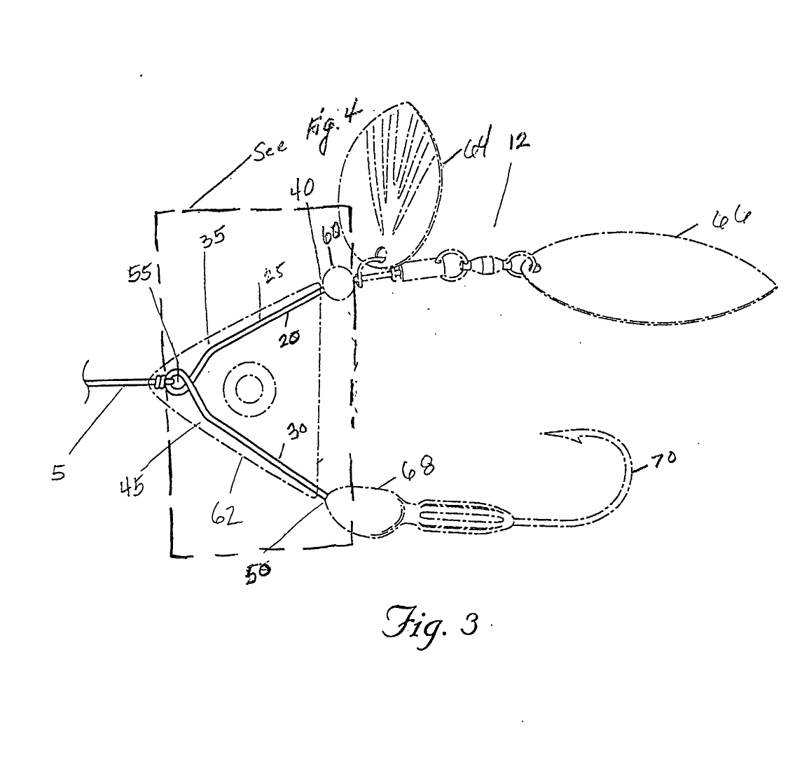

FIG. 3 illustrates a spinner-bait lure of the present invention shown with a solid-line, with certain aspects of the fishing lure not a portion of this invention shown in dashed-line. The spinner-bait fishing lure 12 of the present invention is comprised of a generally V-shaped wire frame member 20 having an eye 55 at the vertex of the V shape, an upper leg 25 and a lower leg 30. The eye 55 serves as the location to knot the fishing line 5 to the lure 12. The eye 55 is formed by a non-twisted loop in the wire member 20. The purpose of this non-twisted loop eye design is twofold. First, the eye loop 55 formed by crossing the wire member 20 prevents the knot of the fishing line 5 from slipping out of the eye 55 to along either leg 25 or 30 of the wire member 20 of the lure 12. Secondly, the non-twist aspect of the eye loop 55 enables the use of certain high strength materials, such as titanium, for the wire member 20 that otherwise could not be used if the eye loop 55 were twisted. It is noted that the non-twist aspect of the eye loop 55 can be used with any suitable material, not limited to titanium. Titanium sustains memory and this property makes it a difficult material for twisting wire members.

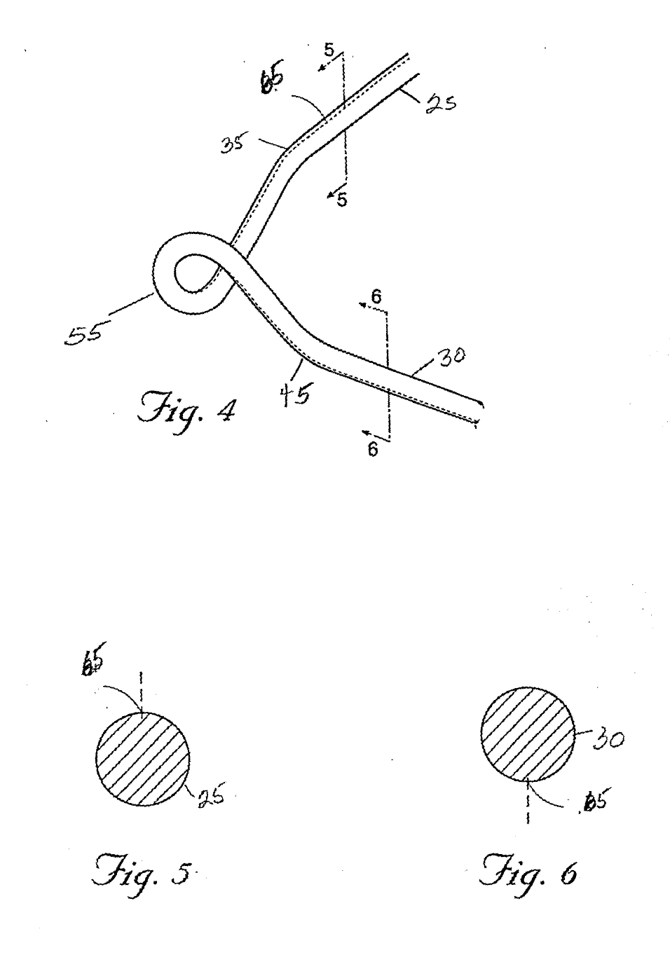

FIGS. 4-6 illustrates the non-twist aspect of the eye loop 55 of this invention. A reference line 65 is provided, demonstrating how the reference line 65 would follow along the top surface of the upper leg 25, shown in FIG. 5, along through the eye loop 55 to lie on the bottom surface of the lower leg 30, shown in FIG. 6.

In a preferred embodiment of this invention, the wire member 20 is made of titanium or titanium alloys. Enabled by the non-twisted design of the eye loop 55, the use of titanium for the wire member 20 provides the lure 12 with superior strength and memory qualities that enable the lure 12 to sustain superior performance after repeated casting and retrieving.

Unlike conventional spinner-bait fishing lure wire frames, the second feature of this invention are bends located along the upper leg 25 and lower leg 30 of the wire member 15. As shown in FIG. 3, the upper 25 and lower 30 legs of a spinner-bait lure 12 provide a mount to attach a plug weight 68 and hook 70, as well as other accessories such as fish shields 62, spinner blades 64, spoons 66 and other miscellaneous accessories. Such miscellaneous attachments and accessories are shown in dashed-line in FIG. 3.

In this invention illustrated in FIG. 4, bends are located along the upper 25 and lower legs 35 near the eye loop 55. The first bend 35 is located near the eye 55 of the wire member along the upper leg 25. The second bend 45 is near the eye along the lower leg 25. In the preferred embodiment, bends 35 and 45 are generally symmetric to one another. Note that the bends 35 and 45 are shown generally symmetric to one another, but are not required to be.

In another embodiment, a third bend (not shown) can be located along the upper leg 25 further away from the eye 55 than the first bend 35. Similarly, a fourth bend (not shown) can be located along the lower leg 30 further away from the eye 55 than the second bend 45.

Bends 35 and 45 (in addition to optional third and fourth bends, not shown) serve to provide optimum support along the length of the wire member 20 for an attached shield member 62, or to prevent unwanted movement of other accessories. In addition, a bend 45 in combination with a slide ball 60 prevents spinner blades 64, spoons 66 and other attachments from sliding out-of-place.

The above-described embodiments of this invention are merely descriptive of its principles and are not to be limited. The scope of this invention instead shall be determined from the scope of the following claims, including their equivalents.

What is claimed is:

1. A spinner-bait fishing lure frame comprising a generally V-shaped wire member comprising:
an eye at the vertex of said V-shaped wire member generally shaped in a non-twisted loop for tying a fishing line to said wire frame member; and
an upper and a lower leg of said wire member.

2. A spinner-bait fishing lure according to claim 1, the lure further comprising an attachment carried by said upper leg.

3. A spinner-bait fishing lure according to claim 2, wherein said attachment is a spinner blade.

4. A spinner-bait fishing lure according to claim 2, wherein said attachment is a spoon.

5. A spinner-bait fishing lure according to claim 2, wherein said attachment slide ball.

6. A spinner-bait fishing lure according to claim 1, the lure further comprising attachments carried by said lower leg.

7. A spinner-bait fishing lure according to claim 6, wherein said attachment is a spinner blade.

8. A spinner-bait fishing lure according to claim 6, wherein said attachment is a spoon.

9. A spinner-bait fishing lure according to claim 6, wherein said attachment is a slide ball.

10. A spinner-bait fishing lure according to claim 1 in which said wire frame member comprises titanium.

11. A spinner-bait fishing lure frame comprising a generally V-shaped wire member with an eye and an upper and a lower leg comprising:
a first bend located near said eye of said wire member along said upper leg;
a second bend located near said eye of said wire member along said lower leg;
wherein said wire member is not twisted.

12. A spinner bait according to claim 11, the bait further comprising:
a third bend located along said upper leg further away from said eye than said first bend; and
a fourth bend located along said lower leg further away from said eye than said second bend.
